(19) United States
(12) Patent Application Publication
(10) Pub. No.: US 2004/0089806 A1
(43) Pub. Date: May 13, 2004

(54) Heating drying type infrared radiation moisture meter

(76) Inventors: Osamu Murakami, Tokyo (JP); Mitsuyuki Ichikawa, Tokyo (JP); Akihiro Okano, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/688,878

(22) Filed: Oct. 21, 2003

(30) Foreign Application Priority Data
Oct. 31, 2002 (JP) 2002-319079

(51) Int. Cl. G01J 5/00

(52) U.S. Cl. 250/338.1

(57) ABSTRACT

A heating drying type infrared moisture meter which detects the temperature of a sample heated and dried on a sample plate 4 by using temperature detection means for carrying out moisture content determination, wherein said temperature detection means is a radiation thermometer 10 which is covered with a heat insulating material, being disposed aslant above the sample plate 4 with a definite separation from a sample on the sample plate 4 being provided, and which light receiving portion is provided with a removable clear protection cover 26, and a heating reference element 17 for carrying out temperature calibration of the radiation thermometer 10 is removably disposed inside of said sample plate 4.

### FIELD OF THE INVENTION

The present invention relates to a heating drying type infrared radiation moisture meter for carrying out determination of the moisture content of, for example, grain.

### BACKGROUND

A conventional exemplary heating drying type infrared radiation moisture meter will be described with reference to FIG. 7.

With a conventional exemplary heating drying type infrared radiation moisture meter as shown in FIG. 7, a load meter 35 is disposed in the inside of a box-like cabinet 38, and at the upper end of a weighing column 35a for this load meter 35, a saucer 34 and a sample plate 31 for placing a sample thereon are mounted.

Above the cabinet 38, a reflecting plate 36 and a lower windscreen 32b are fixed such that they surround the weighing column 35a, and above the lower windscreen 32b, an opening and closing type upper windscreen 32a is disposed such that it surrounds the sample plate 31.

In the inside of the above mentioned upper windscreen 32a, an infrared lamp 33 and a temperature sensor 37 using a thermistor are disposed. By means of the infrared lamp 33, a sample on the sample plate 31 is irradiated with infrared radiation to heat it for evaporating the moisture contained in the sample, and the weight of the sample is measured to perform the prescribed calculation for determining the moisture content of the sample.

The temperature sensor 37 detects the sample temperature for on/off control of the infrared lamp 33.

With a conventional exemplary heating drying type infrared radiation moisture meter as shown in FIG. 7, it is originally ideal that the surface temperature of the sample is detected by the temperature sensor 37, however, it is actually difficult.

The temperature detected by said temperature sensor 37 is neither the temperature of the infrared lamp or the surface temperature of the sample. In detail, the temperature detected by said temperature sensor 37 is a combination of the temperature of the so-called radiant heat which is as a result of the temperature sensor 37 itself absorbing the infrared radiation emitted from the infrared lamp 33 with the ambient temperature in the chamber formed by the upper windscreen 32a.

In this case, if the relationship between the temperature detected by the temperature sensor 37 and the temperature of the sample surface is always constant, there arises no problems. In other words, if the temperature sensor 37 can precisely detect the temperature, the temperature of the sample surface can also be precisely controlled. However, actually, such relationship is not always constant for the following reasons:

(1) The relative distances among the infrared lamp 33, the temperature sensor 37, and the sample surface to one another may vary from unit to unit, which results in a multiple error.

For example, if the distance between the infrared lamp 33 and the temperature sensor 37 is shorter than the specified one, the energy density of the infrared radiation in the vicinity of the temperature sensor 37 is higher than the specified value, the temperature of the temperature sensor 37 reaches the setting temperature at a higher speed, thus, the infrared lamp itself is controlled at a value lower than the desired value, which causes the surface temperature of the sample to be controlled at a lower value.

(2) An error due to the difference in the ambient temperature in the chamber at the start of measurement may be produced.

In detail, the ambient temperature in the chamber at the start of measurement for the first time in a particular day is near the room temperature, however, the ambient temperature in the chamber at the start of measurement for the second and third times is raised under the influence of the measurement for the last time. In addition, the value of increase in temperature may vary. Such a difference in temperature between ordinal numbers of measurement may cause an error.

Specifically, as shown in FIG. 8, assuming that the control temperature is set at 120° C., and the temperature of the temperature sensor at the start of measurement for the first time is 25° C., the temperature of the temperature sensor at the start of measurement for the second time would be 70° C., which would result in the required time period of heating (full-power heating) by the infrared lamp 33 for the first time of measurement being “a”, compared to “b” for the second time of measurement, which would create a difference in the dried condition between samples sequentially placed on the sample plate 31.

(3) A difference in color between samples may produce an error.

With said conventional exemplary heating drying type infrared radiation moisture meter as shown in FIG. 7, the infrared lamp 33 is controlled such that the temperature of the temperature sensor 37 is constant, and the difference in color between samples have not been considered. However, actually, if the color is different between samples, the absorption factor will also differ from sample to sample, and thus if the temperature of the temperature sensor 37 is kept constant, an error due to the difference in surface temperature between samples may be caused.

The present invention has been developed in consideration of the above stated conventional situation, and is intended to provide a heating drying type infrared radiation moisture meter which allows a precise measurement of the moisture content of the sample to be carried out independently of the ambient temperature in the chamber at the start of measurement, with no errors due to a difference in color between samples being produced.

### SUMMARY OF THE INVENTION

Here is a summary of the present invention.

The present invention provides:

[1] A heating drying type infrared moisture meter which detects the temperature of a heated and dried sample by using temperature detection means for carrying out moisture content determination, wherein said temperature detection means is configured with a radiation thermometer which carries out infrared radiation detection.

[2] The heating drying type infrared moisture meter according to [1], wherein said radiation thermometer is disposed just above, aslant above, just under, or aslant under a sample plate, which is a component of said heating drying type infrared moisture meter, with a definite separation from a sample on the sample plate being provided.

[3] The heating drying type infrared moisture meter according to claim 1, wherein said radiation thermometer is disposed in a location where it is permitted to receive infrared radiation which is conducted through a light conducting member disposed above a sample plate, which is a component of said heating drying type infrared moisture meter.

[4] The heating drying type infrared moisture meter according to any one of the items [1] to [3], wherein said radiation thermometer is covered with a heat insulating material.

[5] The heating drying type infrared moisture meter according to any one of the items [1] to [4], wherein the light receiving portion of said radiation thermometer is provided with a removable clear protection cover.

[6] The heating drying type infrared moisture meter according to any one of the items [1] to [5], wherein a heating reference element for carrying out temperature calibration of the radiation thermometer is removably disposed inside of said sample plate.

According to the invention as defined in the above items [1], [2], and [4] to [6], the heating drying type infrared radiation moisture meter is configured by using a radiation thermometer carrying out infrared radiation detection as temperature detection means, which allows a precise measurement of the moisture content of the sample independently of the ambient temperature in the chamber at the start of measurement, with no errors due to a difference in color between samples being produced.

In other words, the infrared radiation emitted from the surface of the sample is detected by the radiation thermometer (the average detection wavelength ranging from 6.4 to 14 μm) to be subjected to signal processing for determining the surface temperature of the sample, thus an advantage of that, if the relative distances of the heater, the temperature sensor, and the sample surface to one another are changed, no errors as mentioned in the description about the conventional exemplary heating drying type infrared moisture meter will be produced is offered.

In addition, because the surface temperature of the sample is detected with the use of the radiation thermometer, the difference between the ambient temperature in the chamber (in the upper windscreen) at the start of measurement for the first time and that at the start of measurement for the second time can have no effect on the result of measurement, producing no errors as mentioned in the description of said conventional exemplary heating drying type infrared radiation moisture meter.

Further, because the radiation thermometer utilizes an infrared radiation having an average wavelength of 6.4 to 14 μm, no light having a wavelength in the band of the visible light region will be detected, which results in no measurement errors due to a difference in color between samples being caused.

Further, said radiation thermometer is covered with a heat insulating material, thus the effect of the ambient temperature is more reliably eliminated; a high degree of freedom in disposition of the radiation thermometer is provided; a clear protection cover is provided, thus the substances evaporated from the sample and the like can be prevented from getting in the radiation thermometer, while the clear protection cover can be freely replaced with a new one; and a heating reference element for carrying out calibration is provided, thus the temperature calibration can be easily performed.

According to the invention as defined in the item [3], the functional effects of the inventions as defined in the items [1], and [4] to [6] are provided, while said radiation thermometer can be disposed in a lower-temperature environment, and thus the effect of the ambient temperature can be eliminated still more reliably.

[7] A heating drying type infrared moisture meter which detects the temperature of a sample heated and dried on a sample plate by using temperature detection means for carrying out moisture content determination, wherein said temperature detection means is a radiation thermometer which is covered with a heat insulating material, being disposed just above, aslant above, just under, or aslant under the sample plate with a definite separation from a sample on the sample plate being provided, and which light receiving portion is provided with a removable clear protection cover, and a heating reference element for carrying out temperature calibration of the radiation thermometer is removably disposed inside of said sample plate.

According to the invention as defined in the item [7], a heating drying type infrared radiation moisture meter which can provide the functional effects of the inventions as defined in the items [1], [2], and [4] to [6] as a whole can be offered.

[8] A heating drying type infrared moisture meter which detects the temperature of a sample heated and dried on a sample plate by using temperature detection means for carrying out moisture content determination, wherein said temperature detection means is a radiation thermometer which is covered with a heat insulating material; which light receiving portion is provided with a removable clear protection cover; and which is disposed in a location where it is permitted to receive infrared radiation which is conducted through a light conducting member disposed above a sample plate, and a heating reference element for carrying out temperature calibration of the radiation thermometer is removably disposed inside of said sample plate.

According to the invention as defined in the item [8], a heating drying type infrared radiation moisture meter which can provide the same functional effect of the invention as defined in the item [3] can be offered.

### BRIEF DESCRIPTION OF THE DRAWINGS

FIG. 1 is a schematic drawing showing the general configuration of a heating drying type infrared radiation moisture meter according to the present embodiment;

FIG. 2 is a schematic plan view of only the upper windscreen of a heating drying type infrared radiation moisture meter according to the present embodiment;

FIG. 3 is a plan view of a radiation thermometer according to the present embodiment;

FIG. 4 is a sectional view of a radiation thermometer according to the present embodiment;

FIG. 5 is an explanatory drawing showing the configuration of a heating reference element according to the present embodiment;

FIG. 6 is a schematic sectional view showing the critical portion of a modification of the heating drying type infrared radiation moisture meter according to the present embodiment;

FIG. 7 is a schematic configuration drawing showing a conventional exemplary heating drying type infrared radiation moisture meter; and

FIG. 8 is an explanatory drawing showing the time periods required for heating an infrared lamp at the start of measurement for the first time and that for the second time with a conventional exemplary heating drying type infrared radiation moisture meter.

### DESCRIPTION OF THE PREFERRED EMBODIMENT

Hereinbelow, an embodiment of the present invention will be described in detail with reference to the drawings.

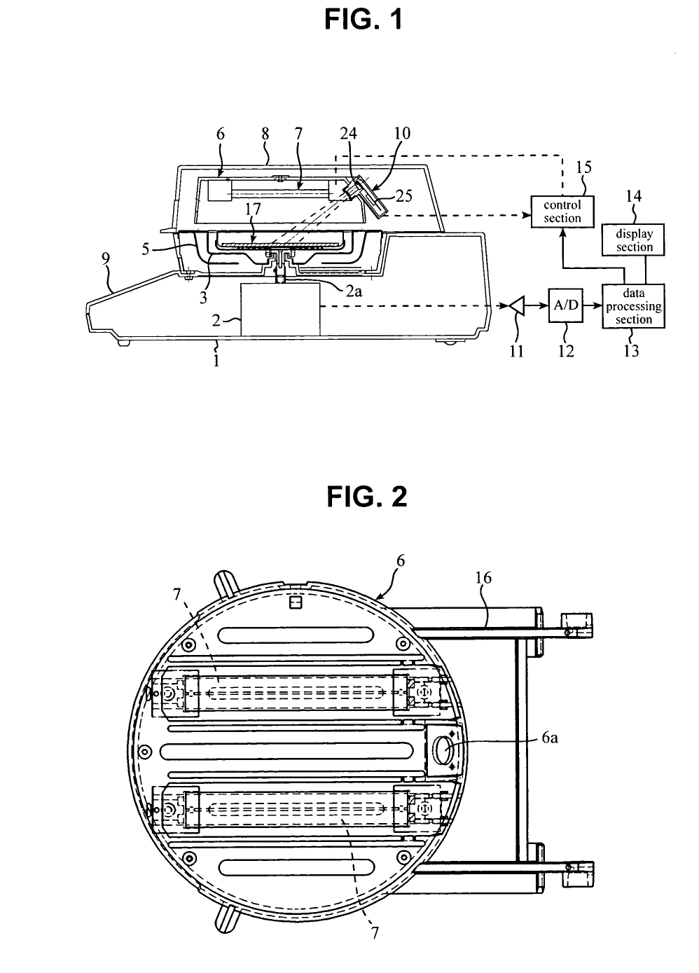

FIG. 1 shows a heating drying type infrared radiation moisture meter according to an embodiment of the present invention. In the inside of a box-like cabinet 1, a load meter 2 for measuring the weight of a sample is disposed, and at the upper end of a weighing column 2a, a saucer 3, for example, a sample plate 4 for placing a sample thereon, such as grain, is mounted.

In the upper portion of the cabinet 1, a lower windscreen 5 is fixed such that it surrounds the saucer 3 at the upper end of the weighing column 2a and the sample plate 4.

Above the lower windscreen 5, a cylindrical upper windscreen 6 which is opened at the bottom, and can be opened and closed, is disposed. In the inside of this windscreen 6, a pair of heaters 7 for heating the sample is mounted in parallel with the top of the sample plate 4.

At the edge of said upper windscreen 6, a radiation thermometer 10 as temperature detecting means that is capable of detecting an infrared radiation (with an average wavelength of 6.4 to 14 μm), which is described later in detail, is disposed aslant above the sample plate 4.

In FIG. 1, a cover to be disposed above the cabinet 1 is indicated at 8, and a control panel for carrying out various operations is at 9.

The heating drying type infrared radiation moisture meter according to the present embodiment is configured such that the sample is heated by said pair of heaters 7 for evaporating the moisture contained therein, the value of the change in weight of the sample that is determined through the load meter 2 being fed to a data processing section 13 through an amplifier circuit 11 and an A/D converter 12, and the data processing section 13 performing the prescribed calculation using the value of the weight before heating the sample for determining the value of the moisture content, which is displayed by a display section 14, such as a liquid crystal display.

The temperature detected by said radiation thermometer 10 and the result of calculation by the data processing section 13 are fed to a control section 15, which uses these for performing heating control of said pair of heaters 7.

Said amplifier circuit 11, A/D converter 12, data processing section 13, display section 14, and control section 15 are actually loaded in the cabinet 1 (the display section 14 being provided in the control panel 9).

FIG. 2 is a plan view showing only said upper windscreen 6 in a perspective manner, and this upper windscreen 6 is provided with support arms 16 for opening and closing operations that are not shown in FIG. 1.

On said sample plate 4, a heating reference element 17 for temperature calibration that is described later is disposed.

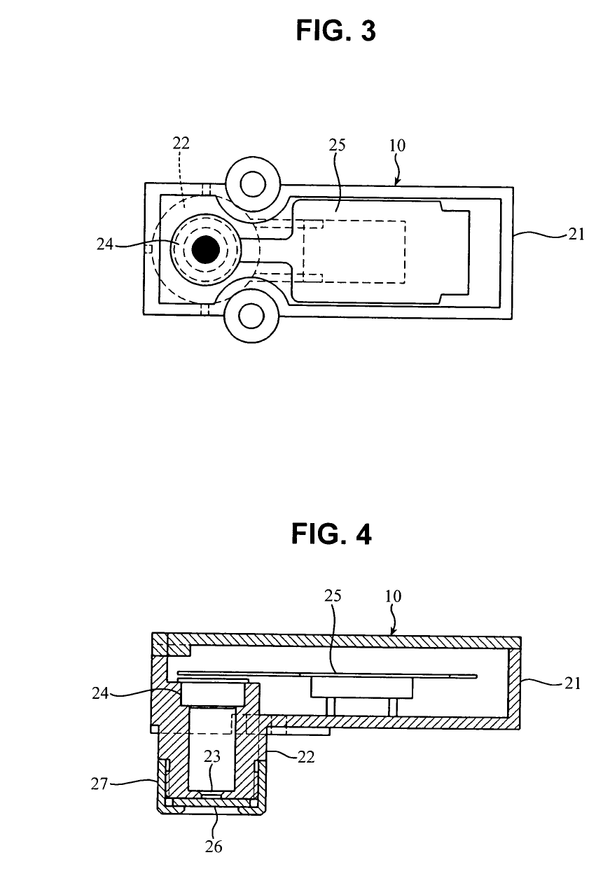

Next, with reference to FIG. 3 and FIG. 4, the radiation thermometer 10 will be described in detail.

With this radiation thermometer 10, a body 21 which is in the shape of a rectangular prism, and a loading cylindrical portion 22 which is projected from one end of the body 21 are integrally configured, and by loading the loading cylindrical portion 22 in a loading hole 6a provided aslant at the edge of said upper windscreen 6, the radiation thermometer 10 is disposed, for example, aslant above the sample plate 4 in the embodiment as shown.

The radiation thermometer 10 can be disposed not only aslant above the sample plate 4, but also, for example, just above, just under, and aslant under the sample plate 4, with a definite separation from the sample being provided. However, when radiation thermometer 10 is disposed just under or aslant under the sample plate 4, the surface temperature of the sample is detected through the sample plate 4 rather than directly, thus, it is preferable that the heat capacity of the sample plate 4 itself be reduced for minimizing the effect of the sample plate 4. To reduce the heat capacity of the sample plate 4, the sample plate 4 may be formed by using a material, such as an aluminum foil, which is thin and good in thermal responsiveness.

At the projection end of said loading cylindrical portion 22, a light receiving opening 23 is provided, and inside thereof, a detector section 24 is disposed. In the inside of the body 21, a thermometer circuit board 25 on which an electronic circuit for operating said detector section 24 and compensating for the temperature drift is fixed.

Said loading cylindrical portion 22 is formed by using a heat insulating material which is excellent in adiathermic, and at the end of the loading cylindrical portion 22 outside the light receiving opening 23, a cap 27 and a removable clear protection cover 26 which is intended to prevent the substances evaporated from the sample, and the like from getting in the radiation thermometer is provided. The clear protection cover 26 can be freely replaced with a new one.

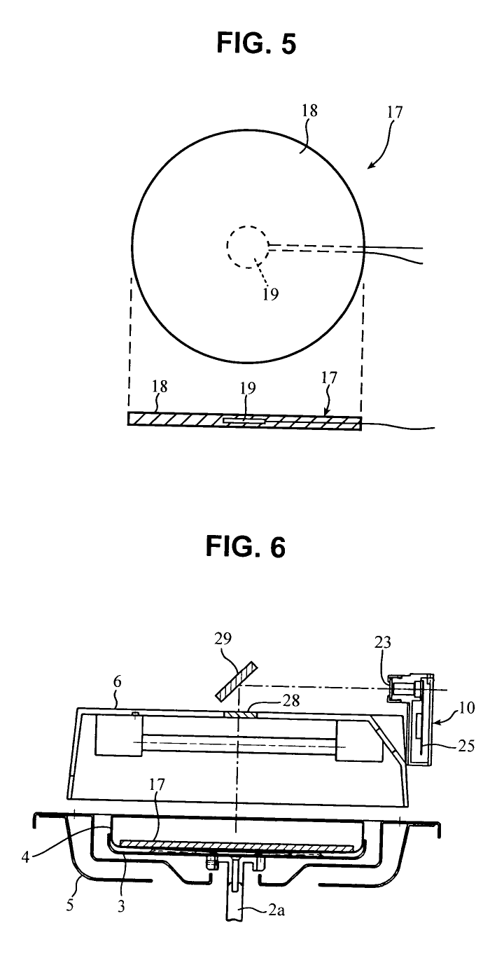

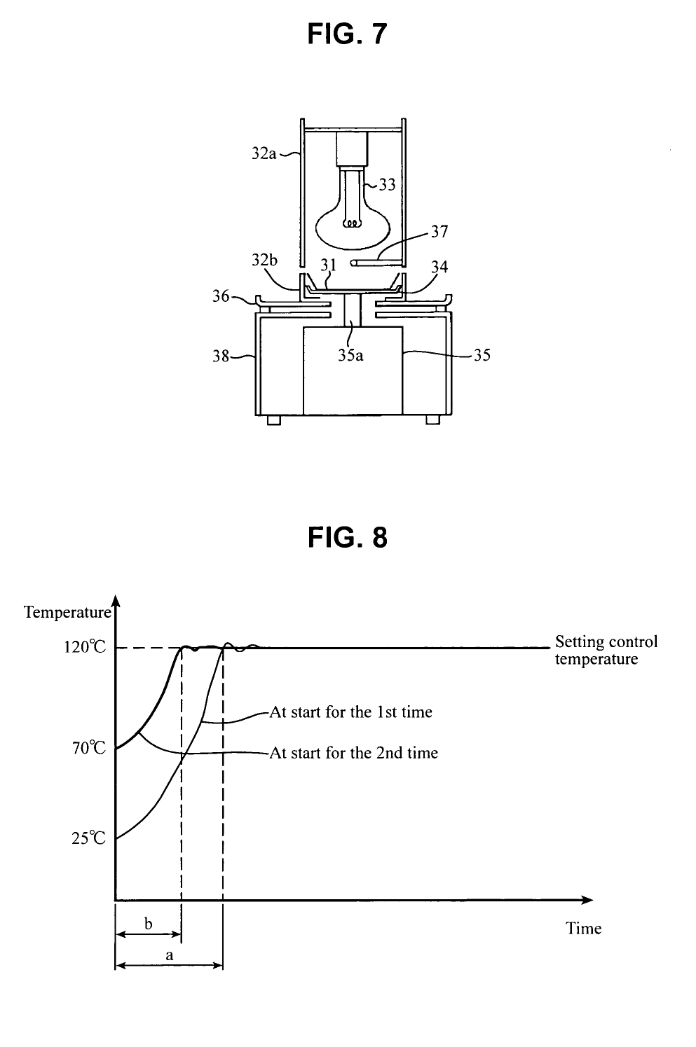

FIG. 5 is a view showing the configuration of the heating reference element 17, and the heating reference element 17 in the embodiment as shown is made of aluminum, being colored black or white, and configured by embedding a reference thermometer 19 (a thermocouple) in a circular disk 18 which is subjected to a surface treatment of alumite (anodizing).

The temperature calibration using the heating reference element 17 is carried out by placing the heating reference element 17 on the sample plate 4, for example, and using the said control panel 9 for setting the temperature calibration mode at the automatic calibration mode to match the temperature of the heating reference element 17 (the reference temperature) to the detection temperature of the radiation thermometer 10. The temperature calibration is performed at each of the temperatures of 80° C., 100° C., 120° C., and 150° C., for example.

Because the operation of the radiation thermometer 10 is such that the detector section 24 of the radiation thermometer 10 detects the infrared radiation emitted from the surface of the sample (the average detection wavelength ranging from 6.4 to 14 μm m) to subject it to signal processing for determining the surface temperature of the sample, the heating drying type infrared radiation moisture meter according to the present embodiment offers an advantage of that, if the relative distances of the heater, the temperature sensor, and the sample surface to one another are changed, no errors as mentioned in the description about the conventional exemplary heating drying type infrared moisture meter will be produced.

In addition, because the surface temperature of the sample is detected with the use of the radiation thermometer 10, the difference between the ambient temperature in the chamber (in the upper windscreen 6) at the start of measurement for the first time and that at the start of measurement for the second time, for example, can have no effect on the result of measurement, producing no errors as mentioned in the description of said conventional exemplary heating drying type infrared radiation moisture meter.

Another advantage is such that, because the radiation thermometer 10 utilizes an infrared radiation having an average wavelength of 6.4 to 14 μm, no light having a wavelength in the band of the visible light region will be detected, which results in no measurement errors due to a difference in color between samples being caused.

Next, with reference to FIG. 6, the critical portion of a modification of the heating drying type infrared radiation moisture meter according to the present embodiment will be described.

In the modification as shown in FIG. 6, the radiation thermometer 10 is disposed in the area outside the upper windscreen 6 that provides a lower-temperature environment, instead of being disposed as shown in FIG. 1.

In detail, the radiation thermometer 10 is fixed being disposed in the vicinity of the upper windscreen 6 with a clear glass plate 28 being mounted in the central portion of the top of the windscreen 6, and thereabove, a mirror 29 as a light conducting member being fixed in the inclined position at an angle of 45 deg for folding the path of the infrared radiation from the sample at an angle of 45 deg, and directing the mirror 29 toward the light receiving opening 23 of the mirror 29. The other configurations of this modification is the same as those of the heating drying infrared moisture meter as shown in FIG. 1.

According to this heating drying type infrared radiation moisture meter as a modification, the effect of the ambient temperature in the upper windscreen 6 can be eliminated still more reliably in addition to the above stated functional effects, because the radiation thermometer 10 is disposed in the area which provides a lower-temperature environment. As a light conducting member, an optical fiber may be used in place of the mirror 29.

According to the present invention, a heating drying type infrared radiation moisture meter can be provided which allows a precise measurement of the moisture content of the sample to be carried out independently of the ambient temperature in the chamber at the start of measurement, with no errors due to a difference in color between samples being produced.

Further, a heating drying type infrared radiation moisture meter can be provided which eliminates the effect of the ambient temperature more positively, offers a high degree of freedom in disposition of the radiation thermometer, permits said clear protection cover for the radiation thermometer to be freely replaced with a new one, while allowing the substances evaporated from the sample and the like to be prevented from getting in the radiation thermometer, and makes it easy to perform the temperature calibration.

What is claimed is:

1. A heating drying type infrared moisture meter which detects the temperature of a heated and dried sample by using temperature detection means for carrying out moisture content determination, wherein said temperature detection means is configured with a radiation thermometer which carries out infrared radiation detection.

2. The heating drying type infrared moisture meter according to claim 1, wherein said radiation thermometer is disposed just above, aslant above, just under, or aslant under a sample plate, which is a component of said heating drying type infrared moisture meter, with a definite separation from a sample on the sample plate being provided.

3. The heating drying type infrared moisture meter according to claim 1, wherein said radiation thermometer is disposed in a location where it is permitted to receive infrared radiation which is conducted through a light conducting member disposed above a sample plate, which is a component of said heating drying type infrared moisture meter.

4. The heating drying type infrared moisture meter according to any one of the claims 1 to 3, wherein said radiation thermometer is covered with a heat insulating material.

5. The heating drying type infrared moisture meter according to any one of the claims 1 to 4, wherein the light receiving portion of said radiation thermometer is provided with a removable clear protection cover.

6. The heating drying type infrared moisture meter according to any one of the claims 1 to 5, wherein a heating reference element for carrying out temperature calibration of the radiation thermometer is removably disposed inside of said sample plate.

7. A heating drying type infrared moisture meter which detects the temperature of a sample heated and dried on a sample plate by using temperature detection means for carrying out moisture content determination, wherein
said temperature detection means is a radiation thermometer which is covered with a heat insulating material, being disposed just above, aslant above, just under, or aslant under the sample plate with a definite separation from a sample on the sample plate being provided, and which light receiving portion is provided with a removable clear protection cover, and
a heating reference element for carrying out temperature calibration of the radiation thermometer is removably disposed inside of said sample plate.

8. A heating drying type infrared moisture meter which detects the temperature of a sample heated and dried on a sample plate by using temperature detection means for carrying out moisture content determination, wherein
said temperature detection means is a radiation thermometer which is covered with a heat insulating material; which light receiving portion is provided with a removable clear protection cover; and which is disposed in a location where it is permitted to receive infrared radiation which is conducted through a light conducting member disposed above a sample plate, and
a heating reference element for carrying out temperature calibration of the radiation thermometer is removably disposed inside of said sample plate.
